(19) United States
(12) Patent Application Publication
(10) Pub. No.: US 2011/0135117 A1
(43) Pub. Date: Jun. 9, 2011

(54) ENHANCED SURROUND SOUND EXPERIENCE

(75) Inventors: Martin NYSTROM, Horja (SE); Ulf Odenlind, Karlstad (SE)

(73) Assignee: Sony Ericsson Mobile Communications AB, Lund (SE)

(21) Appl. No.: 12/631,195

(22) Filed: Dec. 4, 2009

(51) Int. Cl. H04R 3/00

(52) U.S. Cl. 381/122

(57) ABSTRACT

A method and a device configured to be connected to a portable sound recording device for capturing the surrounding sounds are provided. The device includes a right ear arrangement to attach to the right ear of a user and a left ear arrangement to attach to the left ear of the user. The right ear arrangement includes a right microphone arrangement to operatively capture surrounding sounds incident from at least two different directions, and the left ear arrangement includes a left microphone arrangement to operatively capture surrounding sounds incident from at least two different directions.

### TECHNICAL FIELD

The present invention relates to the field of sound recordings and, more particularly, to a device and a method for recording sound. Particular aspects of the invention relate to recording of sounds in a portable device. Other particular aspects of the invention relate to a sound recording arrangement in connection with accessories to a portable device.

### BACKGROUND

Sound can be advantageously captured by using ear mounted microphones to produce recordings including good stereo and surround perception. Here, capturing includes both direct listening and recording for later listening. The optimum placement for ear mounted microphones is inside the ear preferably near the eardrum, or at the Ear Reference Point, i.e. at the border between the outer ear and the ear canal. These placements provide sound captures with a substantially optimal stereo and surround information. Indeed, this is a fact that is commonly utilized in connection with so-called artificial head recordings, see e.g., patent application EP 0 637 188 A1.

Placing a microphone near the eardrum of a user may perhaps be feasible in connection with medical applications or in experimental uses, etc. However, this is not a feasible placement of ear mounted microphones in ordinary commercial applications. Instead, ear mounted microphones for commercial products are typically placed at earplugs in the user's outer ear or even at headphones outside the user's ear.

However, this is a compromise providing sound recordings with stereo and surround information that is less than optimal. Thus, sound captures from microphones placed at earplugs or headphones will not provide the same surround and stereo perception, as it would have if the user heard the sound directly with the user's own eardrums.

In view of the above, a need exists for a sound capturing scheme for ear mounted microphones that can provide recordings with improved stereo and surround information.

### SUMMARY OF THE INVENTION

Embodiments of the present invention provide a sound capturing scheme for ear mounted microphones that provides an improved stereo and surround information to be experienced by a user. Thus, one object of the invention is to provide an improved sound capturing scheme for ear mounted microphones that provides an improved stereo and surround information to be experienced by a user.

According to a first embodiment of the present invention, a plug-in device is configured to be connected to a portable sound recording device for capturing the surrounding sounds. The device may include a right ear arrangement configured to be attached to the right ear of a user, and a left ear arrangement configured to be attached to the left ear of the user. The right ear arrangement may include a right microphone arrangement configured to operatively capture surrounding sounds incident from at least two different directions, and the left ear arrangement may include a left microphone arrangement configured to operatively capture surrounding sounds incident from at least two different directions.

A second embodiment of the invention is directed to a device including the features of the first embodiment. Here, the right ear arrangement may include at least a first right microphone directed in a first right-microphone direction and a second right microphone directed in another second right-microphone direction, so as to operatively capture surrounding sounds incident from two different directions. In turn, the left ear arrangement may include at least a first left microphone directed in a first left-microphone direction and a second left microphone directed in another second left-microphone direction, so as to operatively capture surrounding sounds incident from two different directions.

A third embodiment of the invention is directed to a device including the features of the second embodiment. Here, the right ear arrangement may include at least one additional right microphone directed in an additional right-microphone direction so as to operatively capture surrounding sounds incident from at least one additional direction. In turn, the left ear arrangement may include at least one additional left microphone directed in an additional left-microphone direction so as to operatively capture surrounding sounds incident from at least one additional direction.

A fourth embodiment of the invention is directed to a device including the features of any one of the preceding embodiments. Here, the device may be configured to operatively subject the signals representing the sounds captured by each individual microphone to an individual transfer function for sounds travelling from the position of the microphone in question to the Ear Reference Point of the user, or to the eardrum of the user.

A fifth embodiment of the invention is directed to a device including the features of the fourth embodiment. Here, the device may be configured to operatively summarize the subjected signals representing the sounds captured by the microphones of the right ear arrangement into a right composite signal C1, and to operatively summarize the subjected signals representing the sounds captured by the microphones of the left ear arrangement into a left composite signal C2.

A sixth embodiment of the invention is directed to a device including the features of any one of the preceding embodiments. Here, the microphones of the right ear arrangement may be configured to operatively capture sounds in substantially orthogonal directions with respect to each other, and the microphones of the left ear arrangement may be configured to operatively capture sounds in substantially orthogonal directions with respect to each other.

A seventh embodiment of the invention is directed to a device including the features of any one of the preceding embodiments. Here, the microphones may include directional microphones.

An eighth embodiment of the invention is directed to a device including the features of any one of the preceding embodiments. Here the microphones may be rotatable.

According to a ninth embodiment of the present invention, a sound capturing system may include a plug-in device including the features of any one of the preceding embodiments. In addition, the system may include a portable communication device that is connected to the plug-in device and that may be configured to operatively communicate with another communication device. The system may be configured to operatively capture surrounding sounds by the plug-in device and to operatively send signals C1, C2 representing the captured sounds to the other communication device.

According to a tenth embodiment of the present invention, a method for capturing the surrounding sounds by a plug-in device is provided. The device may include a right ear arrangement with a right microphone arrangement, which ear arrangement may be configured to be attached to the right ear of a user. In addition, the device may include a left ear arrangement with a left microphone arrangement, which arrangement may be configured to be attached to the left ear of the user. The method may include steps of: capturing surrounding sounds incident from at least two different directions by the right microphone arrangement, and capturing surrounding sounds incident from at least two different directions by the left microphone arrangement.

An eleventh embodiment of the invention is directed to a method including the features of the tenth embodiment. Here, the sounds captured by the right microphone arrangement may be captured by at least a first right microphone directed in a first right-microphone direction and a second right microphone directed in another second right-microphone direction. The sounds captured by the left microphone arrangement may be captured by at least a first left microphone directed in a first right-microphone direction and a second left microphone directed in another second right-microphone direction.

A twelfth embodiment of the invention is directed to a method including the features of the eleventh embodiment. Here, the sounds captured by the right microphone arrangement may be captured by at least one additional right microphone directed in an additional right-microphone direction so as to capture surrounding sounds incident from at least one additional direction. The sounds captured by the left microphone arrangement may be captured by at least one additional left microphone directed in an additional left microphone direction so as to capture surrounding sounds incident from at least one additional direction.

A thirteenth embodiment of the invention is directed to a method including the features of any one of the tenth, eleventh, twelfth, or thirteenth embodiment. Here, the signals representing the sounds captured by each individual microphone may be subjected to an individual transfer function for sounds travelling from the position of the microphone to the Ear Reference Point of the user, or to the eardrum of the user.

A fourteenth embodiment of the invention is directed to a method including the features of the thirteenth embodiment. Here, the subjected signals representing the sounds captured by the microphones of the right ear arrangement (22a; 24a; 26a) may be summarized into a right composite signal C1. The subjected signals representing the sounds captured by the microphones of the left ear arrangement may be summarized into a left composite signal C2.

A fifteenth embodiment of the invention is directed to a method including the features of any one of tenth, eleventh, twelfth, thirteenth or fourteenth embodiment. Here, the sounds captured by the microphones of the right microphone arrangement may be captured in directions that are substantially orthogonal directions with respect to each other. The sounds captured by the microphones of the left microphone arrangement may be captured in directions that are substantially orthogonal directions with respect to each other.

A sixteenth embodiment of the invention is directed to a method including the features of any one of tenth, eleventh, twelfth, thirteenth or fourteenth embodiment. Here, the composite signals C1, C2 representing the captured surrounding sounds may be sent to an communication device.

It should be emphasized that the terms “includes/including” and “comprises/comprising” when used in this specification are taken to specify the presence of stated features, integers, steps or components, but do not preclude the presence or addition of one or more other features, integers, steps, components or groups thereof.

It should also be emphasized that the methods defined by the appended claims may include further steps in addition to those mentioned and the steps mentioned may be performed in another sequence than the one given without departing from the present invention.

Further advantages of the present invention and embodiments thereof will appear from the following detailed description of the invention.

### BRIEF DESCRIPTION OF THE DRAWINGS

FIG. 1 shows a schematic illustration of an exemplifying sound capturing system 100 comprising an exemplifying portable device in the form of a cell phone 10 and an exemplifying plug-in device in the form of an earphone arrangement 20a connected to the cell phone 10.

FIG. 2 shows the sound capturing system 100 connected to a cellular network 50.

FIG. 3 shows a schematic illustration of some relevant parts of the cell phone 10 and the sound capturing system 100 in FIGS. 1 and 2.

FIG. 4a is a schematic side view showing details of earpiece 22a and earpiece 22b of the exemplifying earphone arrangement 20a in FIG. 1.

FIG. 4b is a schematic rear view of the earpieces 22a and 22b in FIG. 4a.

FIG. 4c is a schematic illustration of transfer functions H1(s), H2(s), H3(s), H4(s) and associated summation of captured and thus filtered sound signals from microphone arrangements 32a, 34a, 32b, 34b.

FIG. 4d is a schematic side view of the earpieces 22a and 22b wherein the microphone arrangement of earpiece 22a has been rotated.

FIG. 4e is a schematic rear view of the earpieces 22a and 22b in FIG. 4d.

FIG. 5a is a schematic side view showing details of an earpiece 24a and an earpiece 24b of an earphone arrangement 20b, being an embodiment of the earphone arrangement 20a in FIG. 1.

FIG. 5b is a schematic rear view of the earpieces 24a and 24b in FIG. 5a.

FIG. 6a is a schematic side view showing details of an earpiece 26a and an earpiece 26b of an earphone arrangement 20c, being an embodiment of the earphone arrangement 20a in FIG. 1.

FIG. 6b is a schematic rear view of the earpieces 26a and 26b in FIG. 6a.

FIG. 7 is a schematic flowchart illustrating a method according to an embodiment of the present invention.

### DETAILED DESCRIPTION

The present invention is directed to a sound recording system that enables sound to be recorded with an improved stereo and surround information. In embodiments of the invention, the sound captured from microphones placed at earplugs or headphones will provide substantially the same surround and stereo perception as if the user had heard the sound directly with his eardrums.

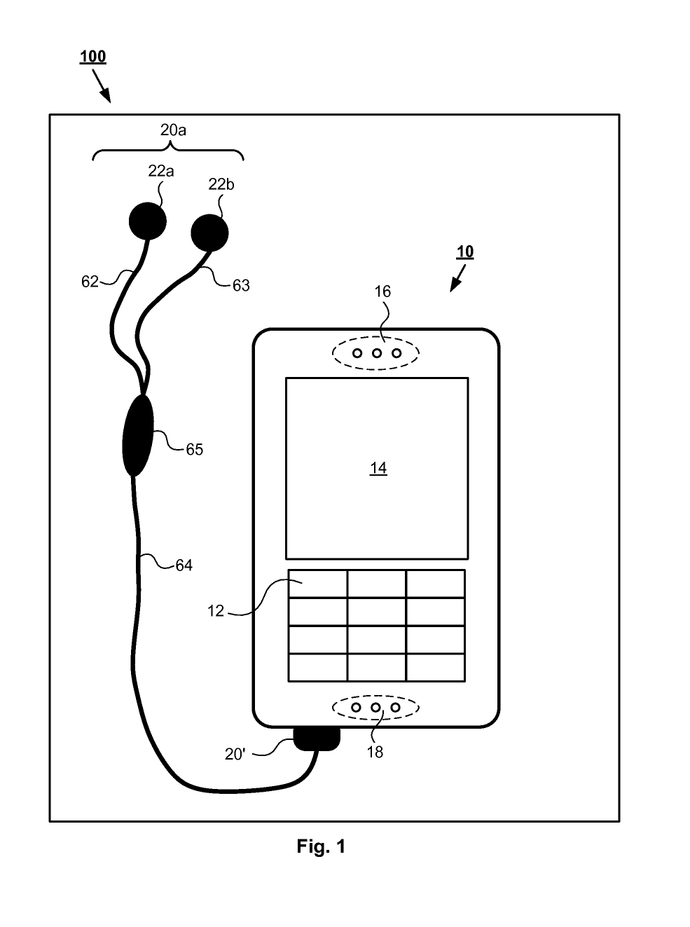

A portable electronic device is schematically illustrated in FIG. 1. The portable device may include a portable communication device, such as a mobile phone, or a cell phone 10. The cell phone may include a built-in antenna (not shown), a keypad 12, a display 14, a speaker 16, and/or a microphone 18. Keypad 12 may be used for entering information such as selection of functions and responding to prompts and display 14 may be used for displaying functions and prompts to a user of cell phone 10. Speaker 16 may be used for presenting sounds such as speech and/or music etc, whereas microphone 18 may be used for recording sounds such as speech and/or music etc. Cell phone 10 may be provided with a connector (not shown) in a well known manner into which a plug-in device can be connected.

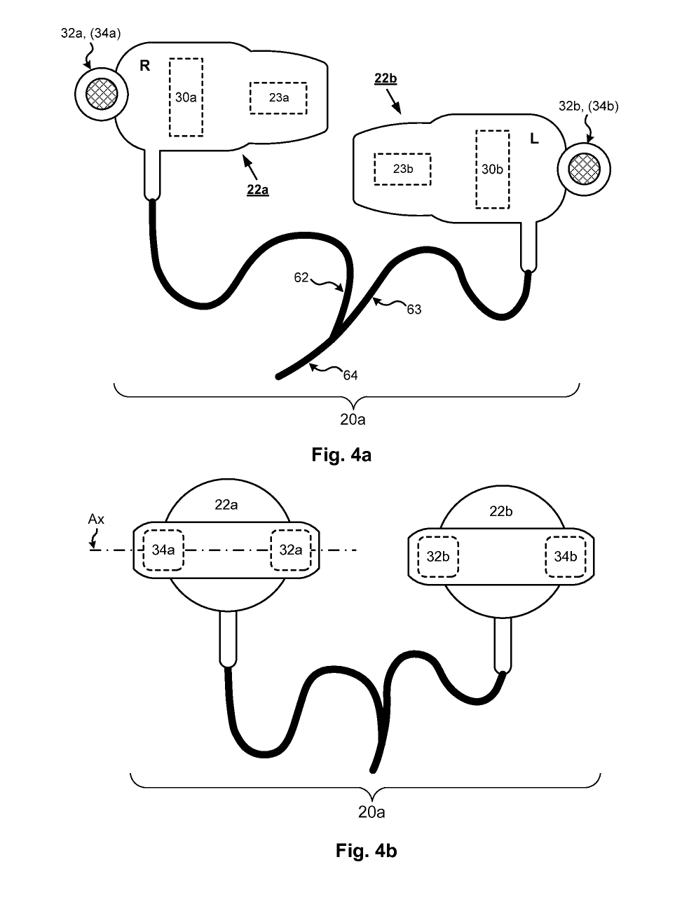

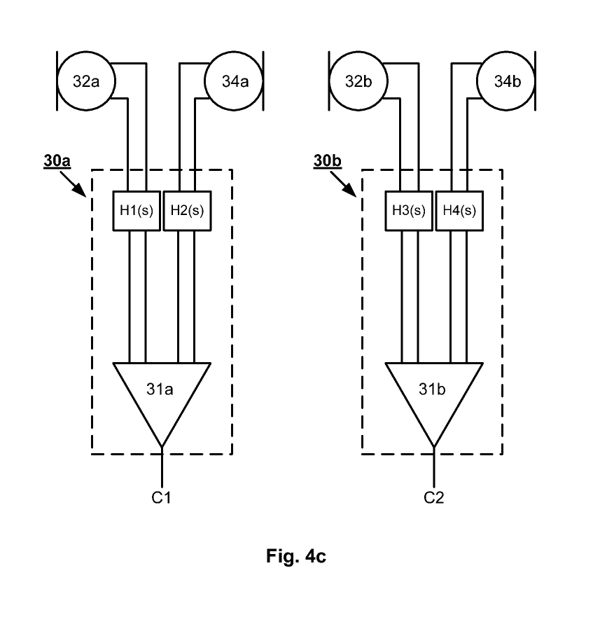

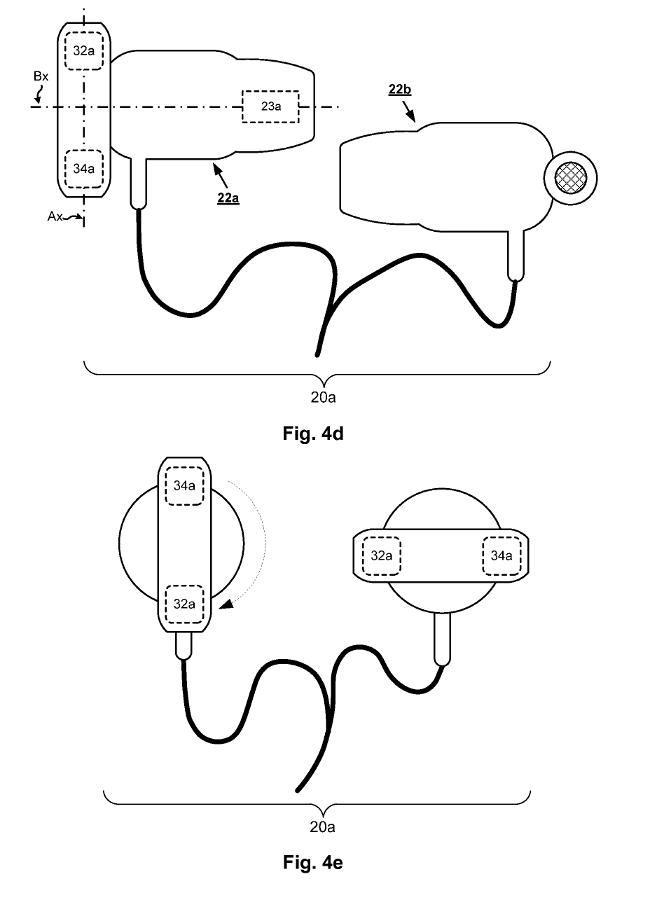

In addition, a plug-in device in the form of an earphone 20a is schematically illustrated in FIG. 1. At one end, earphone 20a may include a connector 20′ arranged to be connected to the connector of cell phone 10, and at the other end, two exemplifying earpieces 22a, 22b. Connector 20′ may be connected to a first cable 64, which may split into two cables 62, 63 connected to earpieces 22a and 22b, respectively. The observant reader realizes that ear piece 22a may be adapted to be attached to one ear of a user, whereas the other ear piece 22b may be adapted to be attached to the other ear of a user. Each earpiece 22a, 22b may be provided with a speaker arrangement 23a, 23b respectively, for presenting sounds to a user of earphone 20a. As will be described later with reference to FIG. 3 and FIG. 4a-4b, each earpiece 22a, 22b may include at least two microphone arrangements 32a, 34a and 32b, 34b, respectively.

It should be emphasized that earphone 20a, including earpieces 22a, 22b with microphones 32a, 43a, 32b, 43b, is merely an example of a plug-in device. Other plug-in devices including other ear arrangements with microphones arranged to be operatively attached in and/or near the outer ear of a user are clearly conceivable, e.g., various headphones or similar with microphones, for example, attached to the ear pads or otherwise near the ear of the user. It should also be emphasized that a plug-in device (e.g., an earphone) need not be connected to a portable device (e.g., a cell phone) or similar device by means of a wired connection. For example, wireless devices, such as Bluetooth devices or similar device, may be advantageously used in embodiments of the present invention. It should also be emphasized that cell phone 10 is merely an example of a portable device in which embodiments of the invention can be implemented. The invention can, for instance, be used in connection with a PDA (personal digital assistant), a palm top computer, a portable music playing device, such as a CD player, an MP3 player, or a cassette player, or a dictation device or any other portable device with sound recording capability. It may be possible to operatively connect a sound capturing plug-in device, such as earphone 20a, to a particular type of sound processing unit of the portable device, for example, a sound recording arrangement and/or a sound transmission arrangement.

Cell phone 10 and earphone 20a in FIGS. 1 and 3, form an exemplifying portable sound capturing system 100 according to an embodiment of the invention.

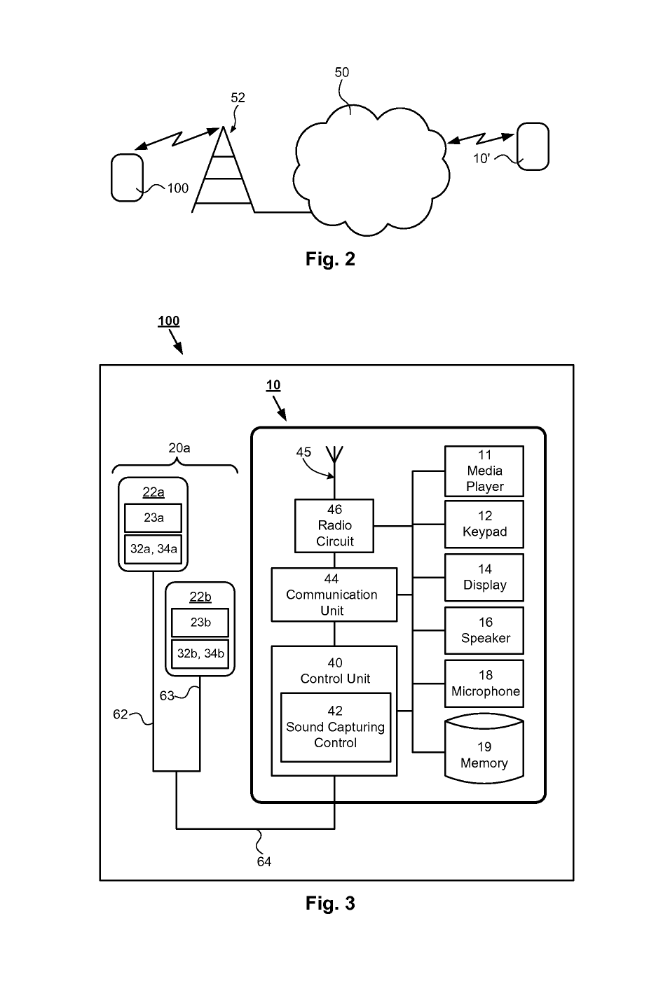

FIG. 2 shows sound capturing system 100, including earphones 20a, and cell phone 10 connected to a communication network 50 via a base station 52. Network 50 may include, for example, a 3G network or a General Radio Packet Service (GPRS) network or any other 2G, 2.5G or 2.75G network or a Long Term Evolution (LTE) network or similar. Indeed, network 50 may be some other type of network, such as Internet, a corporate intranet, a Local Area Network (LAN) or a wireless LAN (WLAN) or other communication network. As schematically illustrated in FIG. 2, cell phone 10 may be connected via network 50 to another communication device 10′, e.g., another cell phone of suitable type or a Personal Computer (PC) or other device. In this manner, sound captured by sound capturing system 100 may be communicated to other device 10′, for example, by means of a voice call, a video call, a video conversation, a video blog or an MMS (Multimedia Messaging Service) or other device.

FIG. 3 shows parts of the interior of cell phone 10 relevant to the present invention. As previously explained, cell phone 10 may be provided with keypad 12, display 14, speaker 16, and/or microphone 18. In addition, cell phone 10 may be provided with a memory arrangement 19 for storing captured sound recordings and possibly for general storing purposes such as storing files and software programs to be used by phone 10. Memory arrangement 19 may be any suitable type that is commonly used in connection with portable devices. Moreover, phone 10 may be provided with a media player 11 arranged to operatively presenting sounds recorded by means of the earphone 20a to the user via speaker 16 or earphone 20a itself, e.g., arranged to operatively present sounds from captured sound recordings stored in memory arrangement 19.

Cell phone 10 may also be provided with a built-in antenna 45 connected to a radio circuit 46 for enabling radio communication with network 50, as described above with reference to FIG. 2. Radio circuit 46 may, in turn, be connected to a communication unit 44 arranged for handling outgoing and/or incoming communication to and/or from external units via network 50, e.g., voice calls, video calls, but also messages such as SMS (Short Message Service) and/or MMS etc. In particular, sound captured by earphone 20a or other plug-in device may be transmitted as files or as a streamed transmission from phone 10 to network 50 and further to a receiving device such as communication device 10′. The parts and functions of phone 10 described above may be implemented in conventional cell phones, and thus a detailed description thereof has been omitted.

Furthermore, as can be seen in FIG. 3, a control unit 40 may be arranged within cell phone 10 for controlling and supervising the general operation of phone 10. Control unit 40 may be implemented by means of hardware and/or software and it may include one or several hardware units and/or software modules, for example, one or several processor units provided with or having access to the appropriate software and hardware required by the functions of cell phone 10. As can be seen in FIG. 3, control unit 40 may connect to media player 11, keypad 12, display 14, speaker 16, microphone 18, memory 19, event handling unit 44, and/or radio unit 46. This enables control unit 40 to control and communicate with these units or other devices to, for example, exchange information and instructions with the units. General control units, like control unit 40 described above, may be implemented in conventional cell phones and, thus, a detailed description of control unit 40 has been omitted.

Of particular interest in connection with embodiments of the present invention is sound capturing control 42, added to general control unit 40. Being a part of control unit 40 implies that sound capturing control 42 may be implemented by means of hardware and/or software in the same or similar manner as control unit 40. Sound capturing control 42 may be arranged to operatively receive and process sound signals that are captured by earphone 20a. Sound capturing control 42 may be arranged, for example, to operatively forward such sound signals to communication unit 44 for further communication to other communication device 10′ via communication network 50 as described above. Additionally or alternatively, sound capturing control 42 may be arranged, for example, to operatively cooperate with control unit 40 so as to store such sound signals in memory 19, possibly for a later communication to other devices 10′ or possibly to be presented later to a user via media player 11.

As a particular feature, an embodiment of sound capturing control 42 may be arranged to operatively perform filtering and summation of sound signals received from the microphone arrangements of at least one earpiece or similar device, for example, from microphone arrangements 32a, 34a of earpiece 22a and/or from microphone arrangements 32b, 34b of earpiece 22b. The filtering and summation function will be discussed further below with reference to FIG. 4c, and embodiments of the microphone arrangements will be discussed below with reference to FIGS. 4a-4b and 4d-6b.

FIG. 4a is a schematic side view of two exemplifying earpieces 22a and 22b of the earphone 20a. Earpieces 22a, 22b may be adapted to be attached to the pinna (i.e., the visible part of the ear) of the user's ear. Earpieces 22a, 22b may be at least partly fitted in the opening of the ear canal or possibly even inside the ear canal of the user. However, other manners for attaching earphone 20a and other ear arrangements to the user's ear are clearly conceivable, for example, by means of arrangements that extends at least partly around the ear of the user and/or by means of clamping arrangements or similar. As can be seen in FIG. 4a, earpiece 22a may be provided with at least two microphone arrangements 32a, 34a, of which microphone arrangement 32a is visible in FIG. 4a. Similarly, earpiece 22b may be provided with at least two microphone arrangements 32b, 34b, of which microphone arrangement 32b is visible in FIG. 4a.

FIG. 4b is a schematic rear view of earpieces 22a, 22b in FIG. 4a illustrating that microphone arrangements 32a, 34a of earpiece 22a may be arranged in substantially opposite directions with respect to each other, so as to extend along a common center axis Ax. Microphone arrangements 32a, 34a may extend substantially parallel to a plane that is substantially perpendicular with respect to a center axis Bx (see FIG. 4d) that extends through the center of the earpiece in a direction towards speaker arrangement 23a.

In other words, microphone arrangements 32a, 34a may be arranged so as to capture sound incident from two substantially opposite directions. Microphone arrangements 32a, 34a may be arranged such that when earpiece 22a is operatively attached to the user's ear, microphone arrangement 32a may capture sound incident from a forward direction and microphone arrangement 34a will capture sound incident from a backward direction with respect to the user. Earpieces 22a, 22b may be identical and/or substantially identical, possibly with the exception for adaptations needed to meet differences between the human right and left ear. Thus, the discussion applies mutatis mutandis to earpiece 22b and microphone arrangements 32b, 34b.

As discussed in the Background section, optimum placement for microphones 32a, 34a includes inside the ear, at the eardrum, or at the Ear Reference Point, i.e., at the border between the outer ear and the ear canal. Such placement would provide recordings with substantially all surround information possible. Since this is not a feasible solution in commercial products, microphones 32a, 34a have been placed outside earplug 22a, for example, at the back facing away from the user when earplug 22a is operatively attached to the user's ear.

However, sounds captured by a microphone placed in or near the outer ear of a user as in FIG. 4a-4b, may not be affected by the ear channel and other parts of the inner and/or outer ear through which the sound would have traveled if the microphone would not have been present. The sound propagation from the outer ear to the eardrum highly influences one's perception of the direction of the sound. Thus, sounds captured by such microphones will not provide the same surround and stereo perception as if the user would have heard the sound with his eardrums directly.

However, this can be remedied according to the embodiment of the invention shown in FIGS. 4a-4c.

As described above, the surrounding sound is captured by microphones 32a, 34a and microphones 32a, 34a. The surrounding sound incident from a forward direction with respect to the user is preferably captured by microphones 32a, 32b and the sound incident from a backwards direction with respect to the user is preferably captured by microphones 34a, 34b.

Then a transfer function H(s) is applied to signals representing the sounds captured by each microphone arrangement so as to compensate for the parts of the ear and/or ear channel through which the sound would have propagated if no microphone was present. This is schematically illustrated in FIG. 4c. Here, signals representing sounds captured by microphone 32a may be subjected to a representative transfer function H1(s) (filtering) for sounds travelling from the position of microphone 32a to the eardrum of the user or at least to the Ear Reference Point, and signals representing sounds captured by microphone 34a may be subjected to a representative transfer function H2(s) (filtering) for sounds travelling from the position of microphone 34a to the eardrum of the user or at least to the Ear Reference Point. The resulting signals will then be summarized in a summation arrangement resulting in a first composite signal C1 with an improved stereo and surround information. The transfer and summation functions may be accomplished by a sound capturing control 30a arranged in earpiece 22a and/or by sound capturing control 42 in cell phone 10 or other device. Thus, the structure and function of sound capturing control 30a and sound capturing control 42 may be the same or similar with respect to microphones 32a, 34a.

Similarly, signals representing sounds captured by microphone 32b may be subjected to a representative transfer function H3(s) (filtering) for sounds travelling from the position of microphone 32b to the eardrum of the user or at least to the Ear Reference Point, and signals representing sounds captured by the microphone 34b may be subjected to a representative transfer function H4(s) for sounds travelling from the position of microphone 34b to the eardrum of the user or at least to the Ear Reference Point. The resulting signals will then be summarized to a second composite signal C2 with an improved stereo and surround information. The transfer and summation functions may be accomplished by a sound capturing control 30b arranged in earpiece 22b or by sound capturing control 42 in cell phone 10 or other device. Thus, the structure and function of sound capturing control 30b and sound capturing control 42 may be the same or similar with respect to microphones 32b, 34b.

Signals representing sounds captured by microphones 32a, 34a, 32b, 34b and/or the composite signals C1, C2 now described may be provided to the cell phone or other device for further processing, e.g., processed by sound capturing control 42 and/or stored and/or communicated to another user, e.g., in the form of a voice call, a video call, a video conversation, a video blog, or an MMS (Multimedia Messaging Service) or similar device, as previously describe herein.

When a user listens to two composite signals C1, C2, first composite C1 may be fed to one ear and composite signal C2 may be fed to the other ear. Signals C1, C2 may include high quality stereo and surround information may provide a very good and accurate surround experience. In fact, the surround and stereo perception of the sound may even be the same or substantially the same as if the user had heard the sound directly with his eardrums. It will more or less be as if the user actually was present at the location where the sound was captured. This can be a particularly intriguing effect when such improved surrounding sound is captured together with images, for example, in connection with video call, a video conversation, a video blog, and/or an MMS (Multimedia Messaging Service) or other multi-media.

A transfer function H(s) (filtering) for sounds travelling from the position of microphone 32a, 32b, 34a, or 34b to the eardrum of the user or at least to the Ear Reference Point, may be, for example, obtained by empirical measurements made on models of the human ear and at least the ear channel. Selected or otherwise known sounds may be measured, for example, at the position of the microphone at one end, and at the other end at the position of the eardrum (tympanic membrane), or at the position of the Ear Reference Point. A transfer function may then be obtained by analyzing the differences between the two sound measurements. As an alternative, selected or otherwise known sounds may be transmitted by an omnidirectional sound source placed at microphone position whereas the sound received at the eardrum or at the Ear Reference Point, may be measured. A transfer function may then be obtained by analyzing the differences between the measured sound and the transmitted sound. Indeed, any other model providing a transfer function for sounds at least travelling through the ear channel of the human ear may suffice.

As described above, an embodiment of earpieces 22a and 22b may each include sound capturing control 30a, 30b, respectively, to accomplish the transfer functions H1(s), H2(s) and H3(s), H4(s), respectively, and summation functions 31a and 31b, respectively. However, as also described above, the transfer functions H1(s), H2(s), H3(s), H4(s) and associated summation functions 31a, 31b may alternatively be arranged in cell phone 10 and/or other device.

FIG. 4d is a schematic side view showing earpieces 22a and 22b. Here, microphone arrangement of 32a, 34a of earpiece 22a has been rotated. Microphone arrangement 32b, 34b of earpiece 22b may also be rotated in the same or similar manner, though not shown in FIG. 4a.

FIG. 4e is a schematic rear view of earpieces 22a and 22b in FIG. 4d, in which an exemplifying direction of rotation has been indicated with a dashed arrow. The rotation shown in FIGS. 4d-4e is about 180° in a rotation-plane that is substantially perpendicular with respect to the center axis Ax that extends through the center of the earpiece in a direction towards speaker arrangement 23a, i.e., in a rotation-plane that is more or less vertical when earpiece 22a is attached to the ear of a user. However, the rotation angle of microphone arrangement 32a, 34a may be substantially any angle between 0-360°. In addition, the rotation of microphone arrangement 32a, 34a may be such that microphone arrangement 32a, 34a can be adjusted to rotate in another rotational-plane that deviates from the vertical rotational-plane mentioned above. An advantage of rotating microphone arrangement 32a, 34a is that microphone arrangement 32a, 34a can be adjusted to the anatomy and other requirements of the specific user and to the specific use and sound environment.

Before we proceed it should be emphasized microphone arrangements 32a, 34a may be directional microphones, i.e., microphone arrangements 32a, 34a may be merely capturing sounds incident from substantially one direction, for example, defined by a cone shaped lobe of less than 45° or less than 30° or less than 20° or less than 10°, in contrast to an omnidirectional microphone, which may capture sounds incident from many directions (e.g., front, up, down, sides), e.g., defined by a half-spherical lobe of 180° or more.

It should be emphasized that earphone 20a and earpieces 22a, 22b described above are merely an embodiment of the present invention. Naturally, other embodiments are conceivable. A few additional embodiments will be described in more detail below.

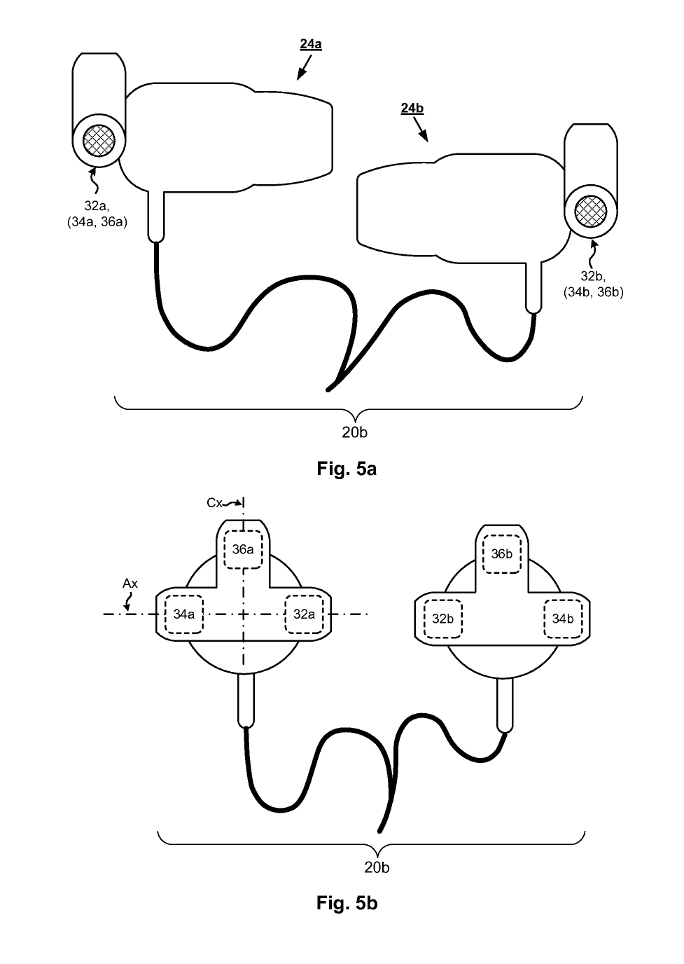

FIG. 5a is a schematic side view showing an earphone 20b including earpieces 24a and 24b. Earphone 20b and earpieces 24a, 24b may be the same or similar as earphone 20a and earpieces 22a, 22b described above. However, earpieces 24a and 24b in FIG. 5a have been provided with additional microphone arrangement 36a and 36b, respectively. Thus, earpiece 24a may include three (3) microphone arrangements 32a, 34a, 36a, and earpiece 24b may include three (3) microphone arrangements 32b, 34b, 36b. Additional microphone arrangements 36a and 36b may be of the same or similar kind as microphone arrangements 32a, 32b, 34a, 34b.

As can be seen in FIG. 5b, additional microphone arrangement 36a may be arranged so as to extend along a center axis Cx that is substantially perpendicular to axis Ax and axis Bx discussed above with reference to FIGS. 4a-4d. In other words, microphone arrangements 32a, 34a, 36a of earpiece 24a may be arranged so as to capture sound incident from three substantially orthogonal directions. When earpiece 24a is operatively attached to the user's ear, microphone arrangement 32a may capture sound incident from a forward direction and microphone arrangement 34a may capture sound incident from a backward direction and microphone arrangement 36a may capture sound incident from an upward or possibly downward direction with respect to the user. Naturally, the same applies, mutatis mutandis, to microphone arrangements 32b, 34b, 36b of earpiece 24b.

In the same or similar manner as previously described for microphone arrangements 32a, 34a of earpiece 22a and microphone arrangements 32b, 34b of earpiece 22b with reference to FIG. 4c, sounds captured by microphone arrangements 32a, 34a, 36a of earpiece 24a, and sounds captured by microphone arrangements 32b, 34b, 36b of earpiece 24b may be subjected to representative transfer functions and then summarized to produce two composite signals. This may increase the experience of a surround sound even further, compared to the two-microphone embodiment of ear piece 22a discussed above with reference to FIGS. 4a-4b.

It should be added that that microphone arrangements 32a, 34a, 36a of earpiece 24a and/or microphone arrangements 32b, 34b, 36b of earpiece 24b may be rotated in the same or similar manner as microphone arrangements 32a, 34a of earpiece 22a described above with reference to FIG. 4d.

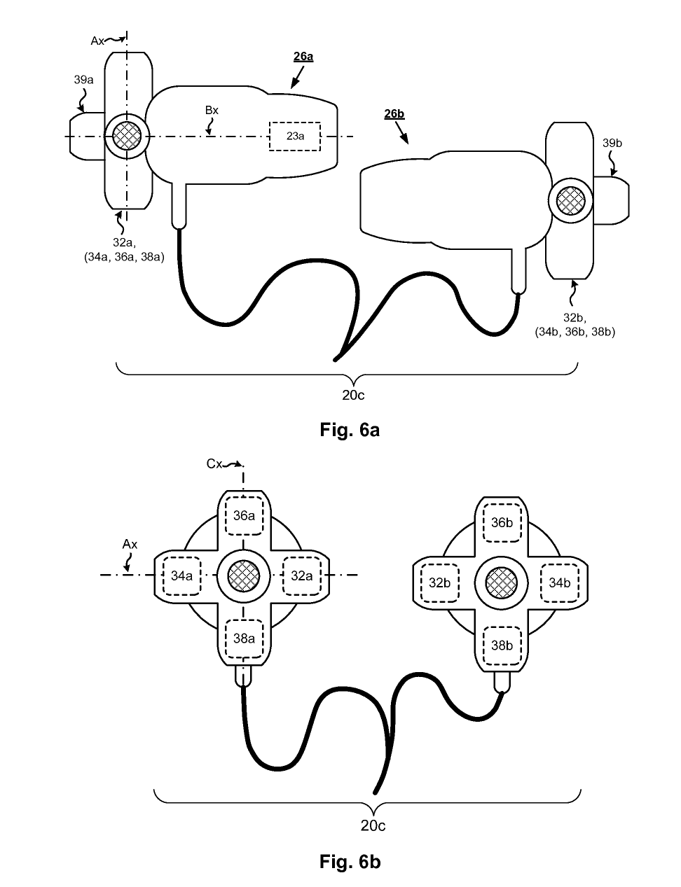

FIG. 6a is a schematic side view showing earphone 20c including earpieces 26a and 26b. Earphone 20c and earpieces 26a, 26b may include the same or similar features as earphone 20b and earpieces 24a, 24b described above. However, each earpiece 26a and 26b in FIG. 6a may be provided with additional microphone arrangements 38a, 39a and 38b, 39b, respectively. Thus, earpiece 26a may include five (5) microphone arrangements 32a, 34a, 36a, 38a, 39a and earpiece 26b may include five (5) microphone arrangements 32b, 34b, 36b, 38b, 39b. Additional microphone arrangements 38a, 39a and 38b, 39b may be of the same or similar type as microphone arrangements 32a, 32b, 34a, 34b discussed above with reference to FIGS. 4a-4b.

As can be seen in FIG. 6b, additional microphone arrangement 38a may be arranged so as to extend along the axis Cx in a direction that is substantially opposite to the direction in which microphone arrangement 36a extends, as discussed above with reference to FIGS. 5a-5d. Moreover, as can be seen in FIG. 6b, additional microphone arrangement 39a may be arranged so as to extend substantially along the axis Bx in a direction that extends outwards from the user when the earpiece 26a is attached to the user. In other words, microphone arrangements 32a, 34a, 36a, 38a, 39a of earpiece 26a may be arranged so as to capture sound incident from five substantially orthogonal directions. When earpiece 26a is operatively attached to the user's ear, microphone arrangement 32a may capture sound incident from a forward direction and microphone arrangement 34a may capture sound incident from a backward direction and microphone arrangement 36a may capture sound incident from an upward direction and microphone arrangement 38a may capture sound incident from a downward direction and microphone arrangement 39a may capture sounds incident from a sideward direction with respect to the user. Naturally, the same applies, mutatis mutandis, to microphone arrangements 32b, 34b, 36b, 38b of earpiece 26b.

In the same or similar manner as previously described for microphone arrangements 32a, 34a of earpiece 22a and microphone arrangements 32b, 34b of earpiece 22b with reference to FIG. 4c, the sounds captured by microphone arrangements 32a, 34a, 36a, 38a, 39a of earpiece 26a, and the sounds captured by microphone arrangements 32b, 34b, 36b, 38b, 39b of earpiece 26b may be subjected to representative transfer functions and then summarized to produce two composite signals. This may increase the experience of a surround sound even further compared to the three-microphone embodiment of earpieces 24a, 24b discussed above with reference to FIGS. 5a and 5b.

It should be added that that microphone arrangements 32a, 34a, 36a, 38a, 39a of earpiece 26a and microphone arrangements 32b, 34b, 36b, 38b, 39b of earpiece 26b may be rotated in the same or similar manner as microphone arrangements 32a, 34a of earpiece 22a described above with reference to FIG. 4d.

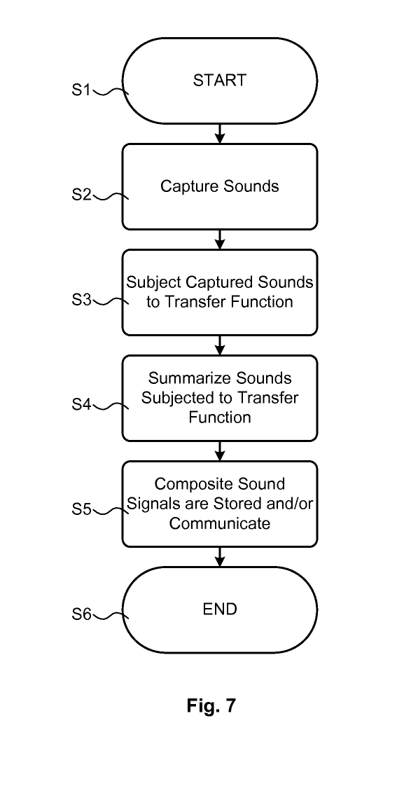

FIG. 7 is a schematic flowchart illustrating a method according to an embodiment of the present invention. The flowchart is discussed below with reference to earphone 20a described above with reference to FIGS. 4a-4b and to cell phone 10 described above with reference to FIGS. 1 and 2. However, the discussion applies, mutatis mutandis, to substantially all plug-in devices and/or portable device with sound recording capability being configured according to embodiments of the present invention, e.g., being configured as exemplified above.

In a first step S1 an initialization of earphone 20a and/or cell phone 10 may be performed. The initialization may include, for example, such actions as activating cell phone 10 and/or earphone 20a.

In a second step S2, the surrounding sounds may be captured by the microphone arrangements of earphone 20a. Here the right ear arrangement 22a including microphones 32a, 34a may capture the surrounding sounds incident from two different directions. Similarly, left ear arrangement 22b including microphones 32b, 34b may capture the surrounding sounds incident from two different directions. Naturally, if there are more microphones, as may be the case in the embodiments described above, it follows that the surrounding sounds incident from several directions may be captured. For example, if N microphones are added to two microphones 32a, 34a of earpiece 20a, it would be possible to capture surrounding sounds incident from 2+N directions. Similarly, if N microphones are added to two microphones 32b, 34b of earpiece 20b it would be possible to capture surrounding sounds incident from 2+N directions.

In a third step S3, the sounds captured by each microphone 32a, 34a, 32b, 34b may be subjected to a transfer function H1(s), H2(s), H3(s), H4(s) for sounds travelling from the position of that microphone 32a, 34a, 32b, 34b to the eardrum of the user or at least for sounds travelling from the position of that microphone 32a, 34a, 32b, 34b to the Ear Reference Point, so as to improve the stereo and surround information associated with the captured sound signals. This should not be interpreted such the sounds captured by all microphones 32a, 34a, 32b, 34b are subjected to all the transfer functions H1(s), H2(s), H3(s), H4(s). On the contrary, only the sounds captured by a specific microphone may be subjected to the transfer function of that microphone. This is illustrated in FIG. 4c, in which sounds captured by microphone 32a may be subjected to transfer function H1(s) associated with that microphone, sounds captured to microphone 34a are subjected to transfer function H2(s) associated with that microphone, sounds captured to microphone 32b are subjected to transfer function H3(s) associated with that microphone, and sounds captured to microphone 34b are subjected to transfer function H4(s) associated with that microphone.

In a fourth step S4, the sounds subjected to a transfer function in the previous step S3 are summarized. This is illustrated in FIG. 4c, in which the sounds from microphone 32a filtered by transfer function H1(s) and the sounds from microphone 34a filtered by transfer function H2(s) may be summarized in a summation arrangement 31a so as to form first composite signal C1 with an improved stereo and surround information. Similarly, the sounds from microphone 32b filtered by transfer function H3(s) and the sounds from microphone 34b filtered by transfer function H4(s) may be summarized in a summation arrangement 31b so as to form second composite signal C2 with an improved stereo and surround information.

In a fifth step S5, composite signals C1, C2 produced by the summarizing in step S4 may be stored for a later listening. The composite signals may be stored, for example, in cell phone 10 or other device, e.g., in memory 19 of cell phone 10. Alternatively, composite signals C1, C2 may be communication via communication network 50 to another device 10′ and/or another user as described above. In this manner, composite signals C1, C2 with an improved stereo and surround properties can be communicated to the user of another device 10′. It will essentially be as if the receiving user actually is present at the location where the sound is captured. This can be a particularly intriguing effect where such improved surrounding sound is communicated together with images, e.g., in connection with a video call, a video conversation, a video blog, and/or an MMS (Multimedia Messaging Service) or other multimedia. Indeed, it may also be a useful tool in connection with support functions. One person may, for example, perform operations on site whereas one or several persons may be online with the on-site person via a video call or similar providing real-time images and sounds. The improved stereo and surround sound will then enhance the ability of the other persons to assist the on-site person.

In a sixth step S6, the exemplifying method may be terminated.

The present invention has now been described with reference to exemplifying embodiments. However, the invention is not limited to the embodiments described herein. On the contrary, the full extent of the invention is only determined by the scope of the appended claims.

1. A plug-in device to connect to a portable sound recording device for capturing the surrounding sounds, comprising:
a right ear arrangement to attach to a right ear of a user and a left ear arrangement to attach to a left ear of the user, wherein:
the right ear arrangement includes a right microphone arrangement to operatively capture surrounding sounds incident from at least two different directions, and
the left ear arrangement includes a left microphone arrangement to operatively capture surrounding sounds incident from at least two different directions.

2. The sound capturing plug-in device according to claim 1, wherein:
the right ear arrangement includes at least a first right microphone directed in a first right-microphone direction and a second right microphone directed in another second right-microphone direction, to operatively capture surrounding sounds incident from two different directions, and
the left ear arrangement includes at least a first left microphone directed in a first left-microphone direction and a second left microphone directed in another second left-microphone direction, to operatively capture surrounding sounds incident from two different directions.

3. The sound capturing plug-in device according to claim 2, wherein:
the right ear arrangement includes at least one additional right microphone directed in an additional right-microphone direction to operatively capture surrounding sounds incident from at least one additional direction, and
the left ear arrangement includes at least one additional left microphone directed in an additional left-microphone direction to operatively capture surrounding sounds incident from at least one additional direction.

4. The sound capturing plug-in device according to any one of claim 2, wherein:
the plug-in device is to operatively subjects the signals representing the sounds captured by each individual microphone to an individual transfer function for sounds travelling from the position of the microphone to an Ear Reference Point of the user or to the eardrum of the user.

5. The sound capturing plug-in device according to claim 4, wherein the plug-in device is to:
operatively summarize the subjected signals representing the sounds captured by the microphones of the right ear arrangement into a right composite signal, and to
operatively summarize the subjected signals representing the sounds captured by the microphones of the left ear arrangement into a left composite signal.

6. The sound capturing plug-in device according to claim 1, wherein:
the microphones of the right ear arrangement are to operatively capture sounds in substantially orthogonal directions with respect to each other, and
the microphones of the left ear arrangement are to operatively capture sounds in substantially orthogonal directions with respect to each other.

7. The sound capturing plug-in device according to claim 1, wherein the microphones are directional microphones.

8. The sound capturing plug-in device according to claim 1, wherein the microphones are rotatable.

9. A sound capturing system comprising a plug-in device according to claim 1, and a portable communication device connected to the plug-in device and configured to operatively communicate with another communication device wherein:
the system is configured to operatively capture surrounding sounds by the plug-in-device, and to operatively send signals representing the captured sounds to the other communication device.

10. A method for capturing surrounding sounds by a plug-in device including a right ear arrangement with a right microphone arrangement and to attach to a right ear of a user, and a left ear arrangement with a left microphone arrangement and to attach to a left ear of the user, the method comprising:
capturing surrounding sounds incident from at least two different directions by the right microphone arrangement, and
capturing surrounding sounds incident from at least two different directions by the left microphone arrangement.

11. The method according to claim 10 wherein:
the sounds captured by the right microphone arrangement are captured by at least a first right microphone directed in a first right-microphone direction and a second right microphone directed in another second right-microphone direction, and
the sounds captured by the left microphone arrangement are captured by at least a first left microphone directed in a first right-microphone direction and a second left microphone directed in another second right-microphone direction.

12. The method according to claim 11, wherein:
the sounds captured by the right microphone arrangement are captured by at least one additional right microphone directed in an additional right-microphone direction so as to capture surrounding sounds incident from at least one additional direction, and
the sounds captured by the left microphone arrangement are captured by at least one additional left microphone directed in an additional left microphone direction so as to capture surrounding sounds incident from at least one additional direction.

13. The method according to claim 10, wherein the signals representing the sounds captured by each individual microphone are subjected to an individual transfer function for sounds travelling from the position of the microphone to the Ear Reference Point of the user, or to the eardrum of the user.

14. The method according to claim 13 wherein:
the subjected signals representing the sounds captured by the microphones of the right ear arrangement are summarized into a right composite signal, and
the subjected signals representing the sounds captured by the microphones of the left ear arrangement are summarized into a left composite signal.

15. The method according to claim 10, wherein:
the sounds captured by the microphones of the right microphone arrangement are captured in directions that are substantially orthogonal directions with respect to each other, and
the sounds captured by the microphones of the left microphone arrangement are captured in directions that are substantially orthogonal directions with respect to each other.

16. The method according to claim 14, further comprising sending the composite signals representing the captured surrounding sounds to a communication device.
